(19) United States
(12) Patent Application Publication
(10) Pub. No.: US 2020/0366109 A1
(43) Pub. Date: Nov. 19, 2020

(54) PORTABLE POWER BANK

(71) Applicant: Ifory Limited, New Territories (HK)

(72) Inventors: Yun Feng, New Territories (HK); Guo-Qin Huang, New Territories (HK); Qi-Jun Yin, New Territories (HK); Shuang-Shuang Chen, New Territories (HK)

(73) Assignee: Ifory Limited, New Territories (HK)

(21) Appl. No.: 16/988,040

(22) Filed: Aug. 7, 2020

(30) Foreign Application Priority Data
Mar. 19, 2020 (CN) 202020351525.0

(51) Int. Cl. H02J 7/00; H04R 1/10; H02J 50/10; H04B 5/00

(52) U.S. Cl. CPC H02J 7/0044; H04B 5/0037; H02J 50/10; H04R 1/1025

(57) ABSTRACT

A portable power bank includes a main body, a charging slot, a back plate, and a charging module. The charging slot is at the back surface of the main body. The charging slot has an accommodating space for receiving an electronic product. The back plate is pivotally connected to the back surface and is movable between a first position and a second position. A first angle is between the back plate at the first position and the back surface, and the back plate at the second position is received on the back surface. The output terminal of the charging module is at the surrounding wall for charging the electronic product. The conversion circuit of the charging module is for converting electricity from the input terminal and outputting to the battery or the output terminal, and converting electricity stored in the battery and outputting to the output terminal.

### CROSS-REFERENCE TO RELATED APPLICATION

This non-provisional application claims priority under 35 U.S.C. § 119(a) to Patent Application No. 202020351525.0 filed in China, P.R.C. on Mar. 19, 2020, the entire contents of which are hereby incorporated by reference.

### BACKGROUND

### Technical Field

This disclosure relates to a portable power bank, in particular, to a portable power bank having a charging slot.

### Related Art

In general, the lithium battery capable of being charged repeatedly is adopted as a power-supplying source that meets the demands of thin and light, economical, and environmental friendly for various portable electronic products, such as wireless earphones, mobile phones, tablet computers, digital cameras, and the like. To charge the lithium battery, one way is to convert the mains supply into the charging power supply with a certain potential by the transformer, and another way is to use a portable power bank for charging when the mains supply is not available.

### SUMMARY

A power bank known to the inventor is electrically connected to the electronic product through, e.g., a cable and a USB connector, and the electricity is converted by a transforming circuit and then the needed electricity can be outputted. However, for those electronic products with small volumes, e.g., wireless earphones, charging with the cable connection is not convenient and such charging manner has some restrictions.

The problem to be solved is to overcome the difficulties met in the portable power bank known to the inventor, namely, electronic products in small volumes cannot be easily connected to the power bank through cables and such charging manner has some restrictions.

In view of these, a portable power bank is provided.

According an embodiment of the instant disclosure, the portable power bank comprises a main body, a charging slot capable of receiving an electronic product, a back plate, and a charging module. The main body has a front surface, a back surface opposite to the front surface, and a side surface connected to the front surface and the back surface. The charging slot is at the back surface and is capable of receiving the electronic product. The charging slot has a surrounding wall, the surrounding wall is recessed inwardly, and an accommodating space is defined by the surrounding wall. The back plate is pivotally connected to an upper edge of the back surface. The back plate is movable between a first position and a second position. When the back plate is at the first position, a first angle is between the back plate and the back surface of the main body. When the back plate is at the second position, the back plate is received on the back surface. The charging module is in the main body. The charging module comprises a battery, an input terminal, an output terminal, and a conversion circuit. The input terminal is exposed from the main body. The output terminal is at the surrounding wall. The conversion circuit is electrically connected to the battery, the input terminal, and the output terminal. The conversion circuit is capable of converting a received electricity from the input terminal into an output electricity and outputting the output electricity to the battery or to the output terminal, and the conversion circuit is further capable of converting a stored electricity in the battery into the output electricity and outputting the output electricity to the output terminal.

In one or some embodiments, the portable power bank further comprises a first cable having a first connector and a second cable having a second connector. The first cable and the second cable are electrically connected to the charging module. The side surface has two side grooves for respectively receiving the first cable and the second cable.

In one or some embodiments, the two side grooves are at different sides of the main body, and the two grooves are symmetrical to each other.

In one or some embodiments, the portable power bank further comprises two side covers for respectively covering the first cable and the second cable. Positions of the two side covers correspond to positions of the two side grooves.

In one or some embodiments, the first connector comprises a type-C connector and the second connector comprises a Lightning connector.

In one or some embodiments, the input terminal of the charging module is at the side surface.

In one or some embodiments, the charging module further comprises a wireless charging coil electrically connected to the conversion circuit and corresponding to the front surface. The conversion circuit converts the stored electricity in the battery or the received electricity from the input terminal into the output electricity and outputs the output electricity to the wireless charging coil.

In one or some embodiments, the portable power bank further comprises a holding plate. The holding plate is pivotally connected to a lower edge of the front surface. The holding plate is movable between a third position and a fourth position. When the holding plate is at the third position, a second angle is between the holding plate and the front surface of the main body. When the holding plate is at the fourth position, the holding plate is received on the front surface.

In one or some embodiments, the front surface has a receiving space for receiving the holding plate. The holding plate is received in the receiving space when the holding plate is at the fourth position, and the front surface has a front finger-shaped recessed portion at an opening portion of the receiving space.

In one or some embodiments, the portable power bank further comprises a holding plate. The holding plate is at a lower edge of the side surface. The holding plate is movable between a third position and a fourth position. When the holding plate is at the third position, the holding plate protrudes from the side surface and the front surface for being configured as a supporting structure having a placing space. When the holding plate is at the fourth position, the holding plate is received on the side surface.

In one or some embodiments, an intersection between the lower edge of the side surface and a lower edge of the front surface has a receiving space for receiving the holding plate. The holding plate is received in the receiving space when the holding plate is at the fourth position.

In one or some embodiments, the surrounding wall has a back finger-shaped recessed portion at an opening portion of the accommodating space.

In one or some embodiments, the main body further has a separation sheet at a center portion of the accommodating space and connected to the surrounding wall.

In one or some embodiments, an area of the back plate is greater than a cross-sectional area of the accommodating space. When the back plate is at the first position, the back plate is capable of exposing the accommodating space from the back surface of the main body and supporting the main body on a loading surface. When the back plate is at the second position, the back plate is capable of being received in the back surface to cover the accommodating space.

According to one or some embodiments of the instant disclosure, the portable power bank has following advantages. The structure of the portable power bank is improved to overcome the difficulties that small electronic products (e.g., wireless earphones) cannot be charged through cables. Moreover, the components of the portable power bank are compactly received in the main body. Furthermore, when the electronic product is mated with the portable power bank, the electricity can be supplied to the electronic product instantly. In the portable power bank according to one or some embodiments of the instant disclosure, the recessed surrounding wall at the back surface of the main body is provided to form an accommodating space for receiving the electronic product, and the output terminal at the surrounding wall are provided for charging. Therefore, the portable power bank has functions of accommodation as well as portable charging. In some embodiments, not only the back surface of the main body is provided for receiving, the front portion of the main body can also be provided for placing devices such as mobile phones, tablet computers, personal digital assistants (PDAs), or the like. In some embodiments, since the portable power bank has the holding plate which forms a supporting structure along with the front surface of the main body, and the angle between the back plate and the back surface of the main body can be adjusted, the user can adjust the viewing angle for the mobile device to meet the ergonomic requirements. Hence, the portable power bank can provide a body-care function and can relieve fatigue on neck and shoulders. In some embodiments, the portable power bank performs the charging function through the wireless charging coil in the main body and/or the cable at the side surface of the main body. Hence, the user can use the portable power bank to perform the charging with various manners.

### BRIEF DESCRIPTION OF THE DRAWINGS

The disclosure will become more fully understood from the detailed description given herein below for illustration only, and thus not limitative of the disclosure, wherein:

FIG. 1 illustrates a perspective view of a portable power bank according to a first embodiment of the instant disclosure;

FIG. 2A and FIG. 2B illustrate schematic views of the portable power bank shown in FIG. 1 at a first viewing angle;

FIG. 3A illustrates a schematic view of the portable power bank shown in FIG. 1 at a second viewing angle;

FIG. 3B illustrates a functional block diagram of the charging module of the portable power bank shown in FIG. 1;

FIG. 4 illustrates a perspective view of a portable power bank according to a second embodiment of the instant disclosure;

FIG. 5 illustrates a perspective view of a portable power bank according to a third embodiment of the instant disclosure;

FIG. 6 illustrates a perspective view of a portable power bank according to a fourth embodiment of the instant disclosure; and

FIG. 7 illustrates a perspective view of a portable power bank according to a fifth embodiment of the instant disclosure.

### DETAILED DESCRIPTION

Embodiments are provided, along with the figures, for facilitating the descriptions of the instant disclosure. It is understood that, a plenty of details are provided for readers to understand the disclosure; however, the inventions of the disclosure are still implementable in the premise that some or all of the details are omitted. In all the figures, same reference numbers designate identical or similar elements. It is worthy to mention that, the figures are provided for illustrative purposes, and are not used to indicate the actual size or number of the element. Moreover, some details may be omitted in the drawings for the sake of clarity for the drawings.

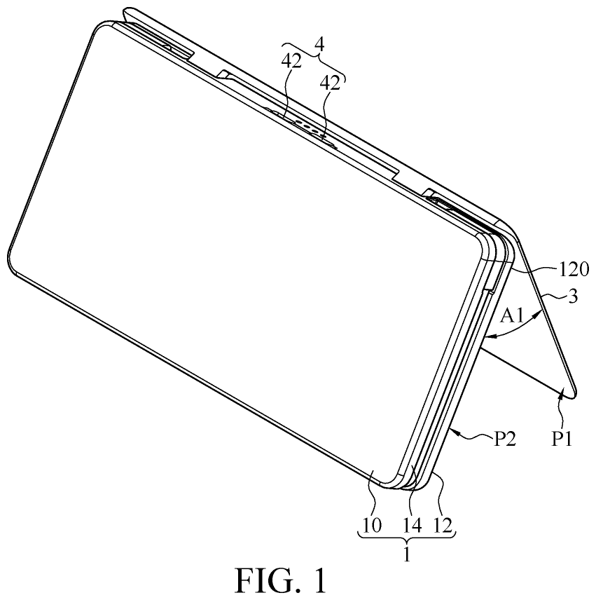

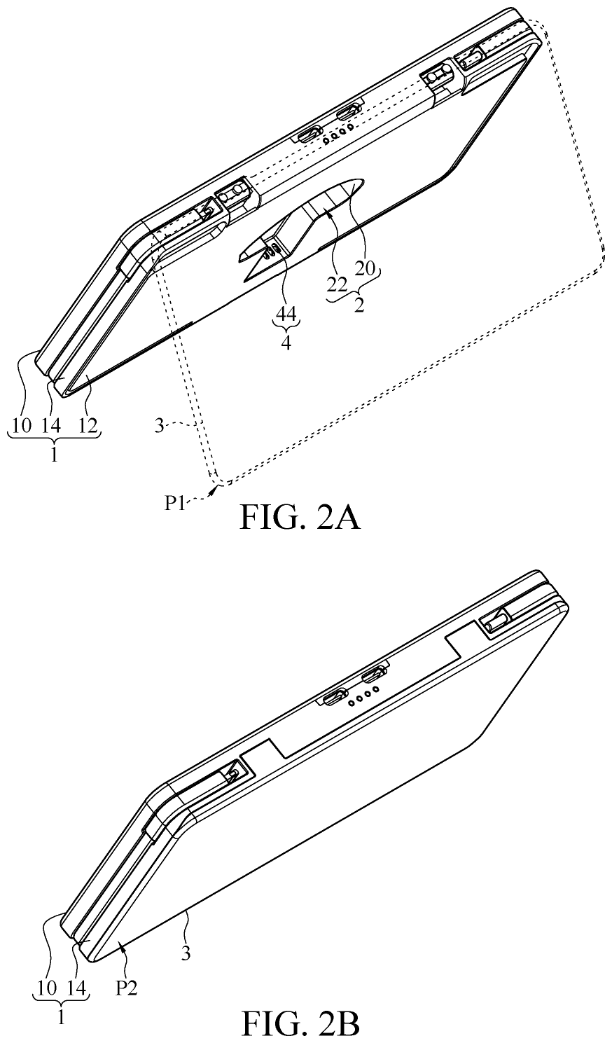

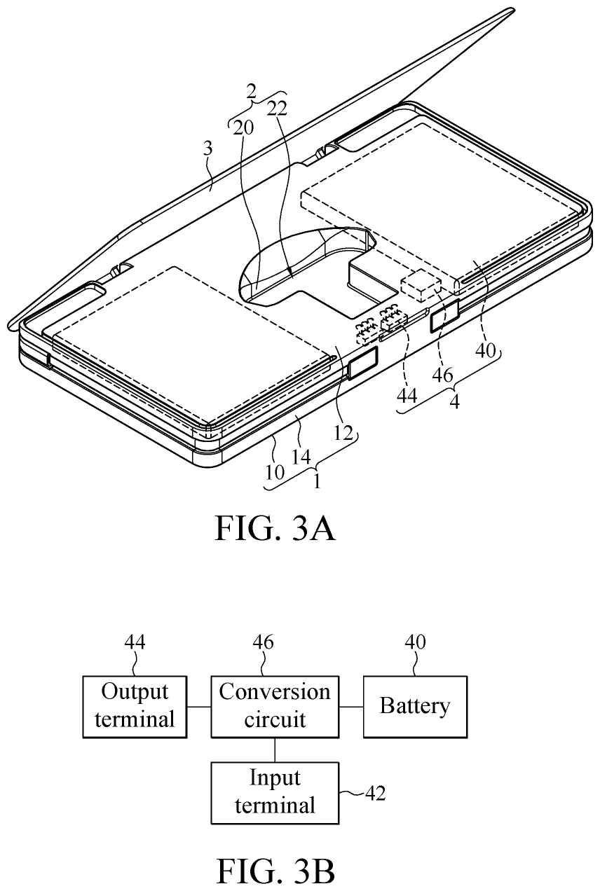

FIG. 1 illustrates a perspective view of a portable power bank according to a first embodiment of the instant disclosure. FIG. 2A and FIG. 2B illustrate schematic views of the portable power bank shown in FIG. 1 at a first viewing angle. FIG. 3A illustrates a schematic view of the portable power bank shown in FIG. 1 at a second viewing angle. FIG. 3B illustrates a functional block diagram of the charging module of the portable power bank shown in FIG. 1.

Please refer to FIGS. 1, 2A, 2B, 3A, and 3B. In this embodiment, the portable power bank comprises a main body 1, a charging slot 2, a back plate 3, and a charging module 4. The main body 1 has a front surface 10, a back surface 12, and a side surface 14. The back surface 12 and the front surface 10 are opposite to each other, and the side surface 14 is connected to the front surface 10 and the back surface 12, respectively. For example, the front surface 10 is a rectangle, the front surface 10 is parallel to the back surface 12, and the front surface 10 and the back surface 12 are at two opposite sides of the side surface 14, so that a main body 1 having a rectangular structure can be configured. In some embodiments, the main body 1 may be an assembled shell structure or a shell structure integrally formed as a one piece member, and the charging module 4 is received in the main body 1. Descriptions are provided in the following paragraphs.

The charging slot 2 is at the back surface 12. The charging slot 2 has a surrounding wall 20 recessed inwardly, and the surrounding wall 20 has an accommodating space 22. In this embodiment, the charging slot 2 is capable of receiving an electronic product through the accommodating space 22. The electronic product may be a small wearable electronic products, such as wireless earphones or a smart watch. The size of the electronic product received in the charging slot 2 is less than the size of the main body 1. In this embodiment, the charging slot 2 is used to receive a pair of wireless earphones. For example, the back surface 12 is a flat surface, and the surrounding wall 20 extends toward the interior of the main body 1 with respect to the flat surface, so that the inwardly-recessed surrounding wall 20 can be configured. In this embodiment, the surrounding wall 20 may be a surrounding vertical side wall, a surrounding inclined side wall, a surrounding curved side wall, or a combination of these walls so as to configure the accommodating space 22. In this embodiment, the charging slot 2 may be an elliptical slot, a semicircular slot, or a rectangular slot, or the charging slot 2 may be a slot having a profile similar to the outline of the electronic product to be received in the charging slot 2, but embodiments are not limited thereto. For example, the geometrical shape of the accommodating space 22 may approximately correspond to the outline of the electronic product. In other words, in this embodiment, the surrounding wall 20 is configured corresponding to the outline of the electronic product to be received in the charging slot 2. Accordingly, during the charging of the portable power bank to the electronic product, the electronic product can be stably received and held in the charging slot 2, so that a proper connection for charging can be provided.

The back plate 3 is pivotally connected to an upper edge 120 of the back surface 12, and the back plate 3 is movable between a first position P1 (as shown in FIGS. 1 and 2A) and a second position P2 (as shown in FIGS. 1 and 2B). The upper edge 120 may be at the intersection between the back surface 12 and the upper side surface 14, or may be at any portion between the boundary of the accommodating space 22 and the upper side surface 14. For example, the upper edge 120 may be a protrusion so as to prevent the back plate 3 from interfering the plug connector connected to the input terminal 42 during the movement of the back plate 3; alternatively, a side of the back plate 3 adjacent to the input terminal 42 may be recessed inwardly to prevent the mechanical interferences between components of the portable power bank.

When the user opens the back plate 3, the back plate 3 is moved to the first position P1, and a first angle A1 is between the back plate 3 and the back surface 12. Hence, the front surface 10 of the main body 1 can support a mobile device, such as a mobile phone, a tablet computer, and the like, and the user can adjust the viewing angle for the mobile device conveniently (related descriptions are provided in the following paragraphs). When the user closes the back plate 3, the back plate 3 is moved to the second position P2 and is received on the back surface 12 of the main body 1, so that the space occupied by the portable power bank can be reduced, and the user can bring the portable power bank conveniently. In general, in some embodiments, the inclined angle of the main body 1 can be adjusted by rotating the back plate 3, so that the main body 1 can be provided as the holder for a mobile device such as a mobile phone.

The charging module 4 is in the main body 1. The charging module 4 comprises a battery 40, an input terminal 42, an output terminal 44, and a conversion circuit 46. The conversion circuit 46 is electrically connected to the battery 40, the input terminal 42, and the output terminal 44, as shown in FIG. 3B. In this embodiment, the battery 40 may be a rechargeable battery, for example, may be a lithium battery. In this embodiment, for instance, the number of the battery 40 may be two, and the two batteries 40 are symmetrically configured at two opposite sides of the accommodating space 22. In the case that the position of the accommodating space 22 is at the edge of the back surface 12, the position of the battery 40 and the position of the accommodating space 22 are configured at the same side, but embodiments are not limited thereto.

The input terminal 42 is exposed from the main body 1, so that an external connector can be applied to be connected to the input terminal 42 to transmit electricity from an external electricity supply source to the portable power bank. The input terminal 42 is provided for receiving the electricity from the external electricity supply source. For instance, the input terminal 42 may be connected to a transmission wire having a transformer so as to be connected to the main supply through the transmission wire. Alternatively, the input terminal 42 may be connected to, through a USB transmission wire, a direct-current electricity supply source (e.g., a computer). In some embodiments, the input terminal 42 may be a USB port, a type-C port, or a Lightning port, but embodiments are not limited thereto.

The output terminal 44 is at the surrounding wall 20 of the charging slot 2, and the output terminal 44 is electrically connected to the electronic product when the electronic product is received in the charging slot 2. For example, the output terminal 44 may be conductive contacts. When the electronic product is received in the charging slot 2, the conductive contacts at the charging slot 2 are in contact with conductive contacts of the electronic product, so that the output terminal 44 is electrically connected to the electronic product. In some embodiments, the output terminal 44 may be several metallic elastic protruding blocks, and the metallic elastic protruding blocks are aligned in a vertical direction or in a horizontal direction. When the electronic product is received in the charging slot 2, the metallic elastic protruding blocks are elastically in contact with the conductive contacts of the electronic product. In some embodiments, the output terminal 44 may be embedded on the surrounding wall 20 of the charging slot 2 or on the bottom portion of the charging slot 2.

The conversion circuit 46 is in the main body 1. In some embodiments, the conversion circuit 46 may be implemented by, for example but not limited to, the circuit trace and electronic components on a printed circuit board. In some embodiments, the conversion circuit 46 may be, but not limited to, a voltage converter. When the input terminal 42 of the portable power bank is connected to the external electricity supply source, the conversion circuit 46 receives the received electricity from the input terminal 42, converts the received electricity into an output electricity having a charging voltage suitable for the battery 40, and outputs the output electricity to the battery 40, so that the battery 40 can be charged. Alternatively, the conversion circuit 46 converts the voltage of the received electricity which is received from the input terminal 42 into the output electricity having the charging voltage suitable for the electronic product and outputs the output electricity to the electronic product through the output terminal 44, so that the electronic product can be charged. In the case that the input terminal 42 of the portable power bank is not connected to the external electricity supply source, the conversion circuit 46 is capable of converting the stored electricity which is stored in the battery 40 into the output electricity having the charging voltage suitable for the electronic product and outputting the output electricity to the output terminal 44, so that the electronic product can be charged. In general, in some embodiments, the conversion circuit 46 may be capable of converting the received electricity which is received from the input terminal 42 into an output electricity and outputting the output electricity to the battery 40 or to the output terminal 44, or the conversion circuit 46 may be capable of converting the stored electricity which is stored in the battery 40 into the output electricity and outputting the output electricity to the output terminal 44.

For example, when an electronic product, such as a wireless earphone, is received in the charging slot 2, the conversion circuit 46 receives the electricity from the battery 40, converts the electricity into the electricity having a suitable voltage, and outputs the electricity to the electronic product in the charging slot 2 through the output terminal 44 at the surrounding wall 20.

Based on the above, according to one or some embodiments of the instant disclosure, the portable power bank can receive the electronic product through the accommodating space 22 of the charging slot 2 properly and charge the electronic product through the output terminal 44 at the surrounding wall 20. Hence, during the charging of the portable power bank to the electronic product, the electronic product can be stably received and held in the charging slot 2, so that a proper connection for charging can be provided. Accordingly, problems of poor charging connection or even charging failures caused by the shaking or the falling off of the portable power bank during the charging can be prevented. Moreover, the difficulties that the electronic products in small volumes cannot be easily charged through cables can be solved. Furthermore, the components of the portable power bank are compactly received in the main body 1. Additionally, when the electronic product is mated with the portable power bank, the electricity can be supplied to the electronic product instantly.

In some embodiments, an area of the back plate 3 is greater than a cross-sectional area of the accommodating space 22; that is, the area of the back plate 3 is greater than the size of the opening of the charging slot 2 at the back surface 12. When the back plate 3 is at the first position P1, the accommodating space 22 is exposed from the back surface 12, and the back plate 3 supports the main body 1, so that the main body 1 can stand on the loading surface. When the back plate 3 is at the second position P2, the back plate 3 is received on the back surface 12 to cover the accommodating space 22. Specifically, in this embodiment, when the user opens the back plate 3, the back plate 3 is moved to the first position P1 and is provided as a supporting member for the main body 1. Hence, the first angle A1 is between the back plate 3 and the back surface 12 of the main body 1. In this embodiment, the front surface 10 of the main body 1 may be provided for supporting a mobile device, e.g., a mobile phone, a tablet computer, a portable multimedia player, or the like, and the user can adjust the viewing angle for the mobile device. When the user closes the back plate 3, the back plate 3 is moved to the second position P2 and is received on the back surface 12 of the main body 1. In this embodiment, when the back plate 3 is received on the back surface 12 of the main body 1, the back plate 3 covers the opening of the charging slot 2 at the back surface 12, so that the electronic product can be received in the portable power bank more firmly and stably.

In an exemplary embodiment, in the case that the back plate 3 is pivotally connected to the intersection between the back surface 12 and the upper side surface 14, the area of the surface plate 3 and the area of the back surface 12 are substantially the same; in the case that the back plate 3 is pivotally connected to the intersection between the back surface 12 and the upper side surface 14, although the area of the back plate 3 is less than the area of the back surface 12, the area of the back plate 3 is greater than the cross-sectional area of the accommodating space 22. Therefore, the charging slot 2 can be completely covered by the back plate 3, so that the electronic product can be properly received in the portable power bank, thus facilitating the electrical connection for charging.

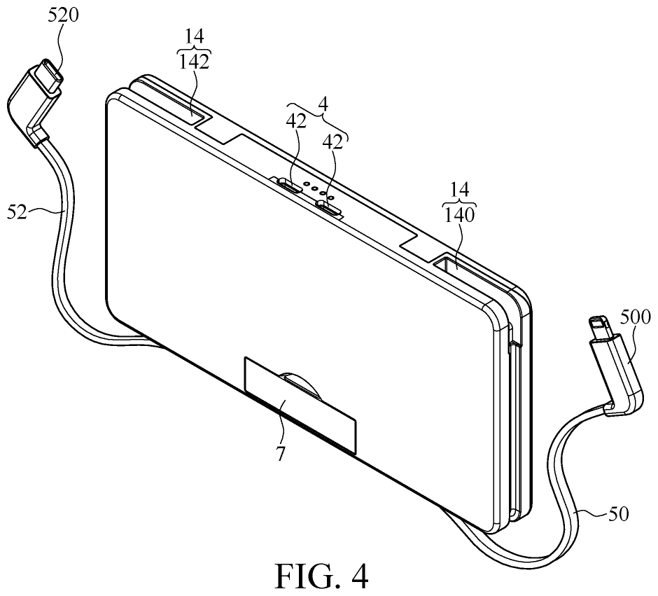

Please refer to FIG. 4. In one embodiment, the portable power bank further comprises a first cable 50 and a second cable 52. The first cable 50 and the second cable 52 are provided for outputting electricity to the mobile device to be charged. In this embodiment, the first cable 50 and the second cable 52 extend out of the main body 1. The first cable 50 further has a first connector 500, and the second cable 52 further has a second connector 520. One of two ends of the first cable 50 and one of two ends of the second cable 52 are electrically connected to the conversion circuit 46 of the charging module 4, respectively. Moreover, the first cable 50 and the second cable 52 pass through the main body 1 from the inner portion of the main body 1, so that the other end of the two ends of the first cable 50 and the other end of the two ends of the second cable 52 are exposed out of the main body 1. The other end of the two ends of the first cable 50 has the first connector 500, and the first connector 500 is provided for connecting to the mobile device to be charged. The other end of the two ends of the second cable 52 has the second connector 520, and the second connector 520 is provided for connecting to the mobile device to be charged. Based on the above, according to one or some embodiments, the connection port of the mobile device to be charged can be electrically connected to the first connector 500 or the second connector 520. Then, the conversion circuit 46 converts the electricity received from the input terminal 42 or the electricity stored in the battery 40 into the output electricity. The output electricity can not only be outputted to the electronic product in the charging slot 2, but also can be outputted to the mobile device to be charged through the first connector 500 and/or the second connector 520.

In some embodiments, the first connector 500 and the second connector 520 may be of the same connection specification, or may be of different connection specifications. For example, the specification of the first connector 500 may be a USB output port, which may be but not limited to, type-C, type-A, or Micro-B. The specification of the second connector 520 may be Lightning. Moreover, the mobile device to be charged may be, for example, a mobile phone, a tablet computer, a portable multimedia player, or other consumer electronics. Accordingly, as compared with a power bank having a connector in a single connection specification known to the inventor, in one or some embodiments, the portable power bank can charge mobile devices with different connection specifications at the same time. For instance, the first connector 500 may be a type-C connector suitable for charging Android mobile devices, and the second connector 520 may be a Lightning connector suitable for charging iOS mobile devices.

In at least one embodiment, the side surface 14 of the main body 1 has two side grooves 140, 142 for respectively receiving the first cable 50 and the second cable 52. For example, when the portable power bank is to charge a mobile device having a connection port mating with the first connector 500, the first cable 50 is taken out of the side groove 140 and electrically connected to the mobile device. After the charging procedure is finished, the first cable 50 is received in the side groove 140. When the portable power bank is to charge a mobile device having a connection port mating with the second connector 520, the second cable 52 is taken out of the side groove 142 and electrically connected to the mobile device. After the charging procedure is finished, the second cable 52 is received in the side groove 142. In an exemplary embodiment, the two side grooves 140, 142 are at different sides of the main body 1 and are symmetrical to each other; therefore, it is more convenient in use and storage of cables. In this embodiment, the two side grooves 140, 142 are respectively at the opposite sides of the main body 1 and surround the side surface 14. For example, the two side grooves 140, 142 respectively extend from the lower edge of the side surface 14 toward the side edge and the upper edge of the side surface 14, the first cable 50 and the second cable 52 extend out of the main body 1 from the lower edge of the side surface 14, and the first cable 50 and the second cable 52 can be winded and received in the two side grooves 140, 142. Moreover, in this embodiment, the first connector 500 and the second connector 520 are received in the two side grooves 140, 142 at the upper edge of the side surface 14 and do not protrude out of the side surface 14, so that the first cable 50 and the second cable 52 can be received in the two side grooves 140, 142 completely, thereby providing a neat appearance for the portable power bank.

In another embodiment, the input terminal 42 of the charging module 4 is at the side surface 14, so that the space in the main body 1 can be utilized properly; in other words, in this embodiment, the input terminal 42 may be embedded on the side surface 14. Preferably, in one embodiment, the input terminal 42 is between the two side grooves 140, 142. Accordingly, the space in the main body 1 can be utilized properly, thereby providing a neat appearance for the portable power bank.

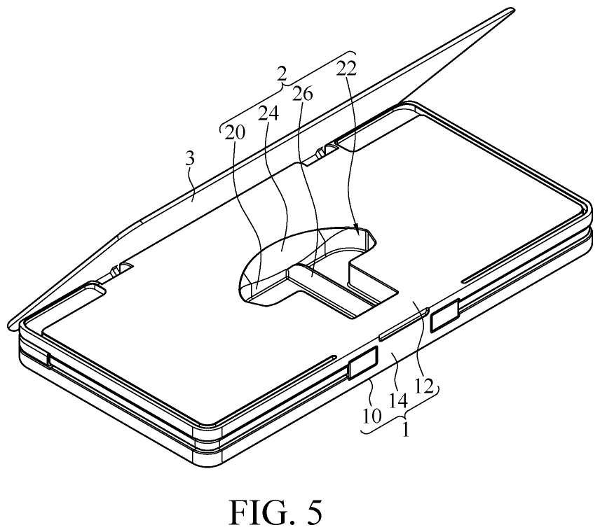

Please refer to FIG. 5. In one embodiment, the surrounding wall 20 has a back finger-shaped recessed portion 24 at the opening portion of the accommodating space 22. In other words, in this embodiment, an arc-shaped curved surface (the back finger-shaped recessed portion 24) is at the intersection between the back surface 12 and the surrounding wall 20 and is recessed toward the inner portion of the main body 1, so that portions of the electronic product can be exposed from the back finger-shaped recessed portion 24, and the user can take or place the electronic product (such as a wireless earphone) bare-handedly.

In another embodiment, the main body 1 further has a separation sheet 26. The separation sheet 26 is at a center portion of the accommodating space 22 and is connected to the surrounding wall 20, so that two sub-accommodating spaces can be divided. The two sub-accommodating spaces are provided for respectively receiving the right part and the left part of the wireless earphone to prevent the two parts from impacting with each other. Accordingly, the wireless earphone can be properly received in the portable power bank, thereby enhancing the electrical connection stability during the charging procedure.

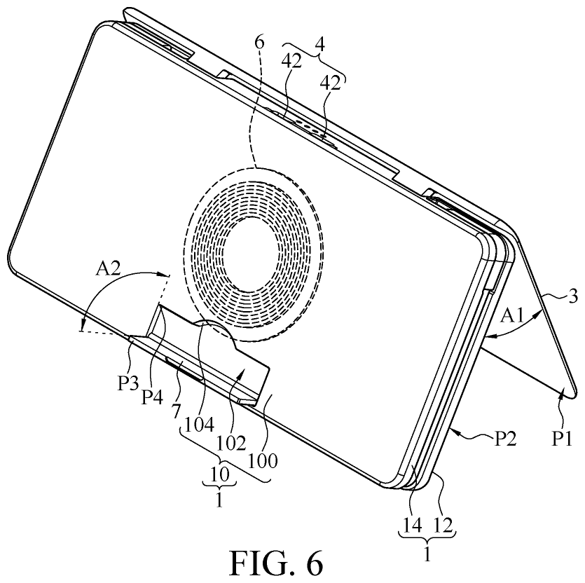

Please refer to FIG. 6. In at least one embodiment, the portable power bank further comprises a holding plate 7. The holding plate 7 is pivotally connected to the lower edge 100 of the front surface 10. Moreover, the pivot portion of the holding plate 7 and the pivot portion of the back plate 3 are respectively adjacent to opposite two side surfaces 14. In this embodiment, the holding plate 7 is movable between a third position P3 and a fourth position P4. When the holding plate 7 is at the third position P3, a second angle A2 is between the holding plate 7 and the front surface 10. When the holding plate 7 is at the fourth position P4, the holding plate 7 is received on the front surface 10. Based on the above, according to one or some embodiments, when the back plate 3 is moved to the first position P1 and provided as the supporting member for the main body 1, the inclined angle of the front surface 10 can be changed by adjusting the first angle A1. Moreover, the outwardly-opened holding plate 7 at the third position P3 and the front surface 10 are together configured to form a supporting structure having a placing space, so that the mobile device can be placed on and abutted on the front surface 10 stably, and the user can adjust the viewing angle for the mobile device by adjusting the inclined angle of the front surface 10. In this embodiment, since the supporting structure can be formed by the holding plate 7 and the front surface 10 of the main body 1, and the angle between the back plate 3 and the back surface 12 of the main body 1 can be adjusted, the user can adjust the viewing angle for the mobile device to meet the ergonomic requirements. Hence, the portable power bank can provide a body-care function and can relieve fatigue on neck and shoulders.

In one embodiment, the front surface 10 further has a receiving space 102 for receiving the holding plate 7. The holding plate 7 is received in the receiving space 102 (as shown in FIG. 4) when the holding plate 7 is at the fourth position P4, and the front surface 10 has a front finger-shaped recessed portion 104 at the opening portion of the receiving space 102. For example, the front finger-shaped recessed portion 104 may be an arc-shaped curved surface for exposing portions of the holding plate 7, and the user can operate the holding plate 7 bare-handedly in a convenient manner. In another embodiment, the receiving space 102 is a groove recessed from the front surface 10 toward the inner portion of the main body 1, and the depth of the groove is substantially the same as the thickness of the holding plate 7. When the holding plate 7 is rotated to the fourth position P4 and received in the receiving space 102, the outmost surface of the holding plate 7 and the front surface 10 are aligned with each other and at the same horizontal plane, but embodiments are not limited thereto.

In some embodiments, the charging module 4 further comprises a wireless charging coil 6. The wireless charging coil 6 is in the main body 1 and corresponds to the front surface 10 of the main body 1. The wireless charging coil 6 is electrically connected to the conversion circuit 46. The wireless charging coil 6 is provided for transmitting electricity wirelessly to the mobile device placed on the front surface 10. Accordingly, the conversion circuit 46 can convert the electricity received from the input terminal 42 into the output electricity, and the output electricity not only can be outputted to the electronic product in the charging slot 2 through the output terminal 44, but also can be outputted to the mobile device for charging the mobile device through the wireless charging coil 6. Moreover, the conversion circuit 46 may convert the electricity stored in the battery 40 into the output electricity and output the output electricity to the wireless charging coil 6 to charge the mobile device.

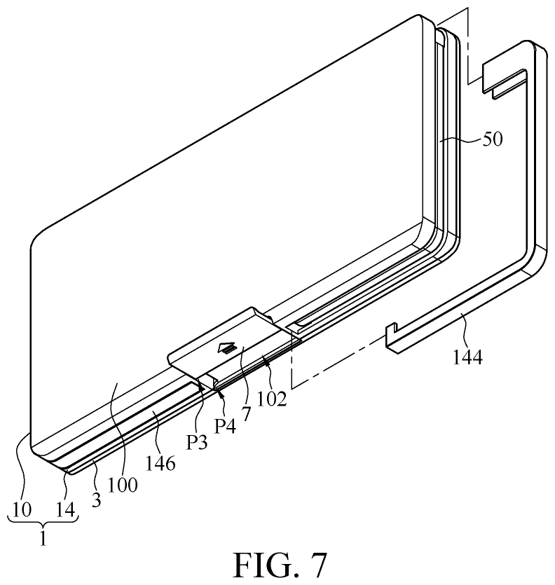

Please refer to FIG. 7. One difference between the embodiment shown in FIG. 6 and this embodiment is that, in this embodiment, the holding plate 7 is at the intersection between the lower edge of the side surface 14 and the lower edge 100 of the front surface 10, and the holding plate 7 is movable between the third position P3 and the fourth position P4 with respect to the lower edge of the side surface 14. For example, the main portion of the holding plate 7 is vertical to the front surface 10. When the holding plate 7 is at the third position P3, the holding plate 7 is moved outwardly from the lower edge of the side surface 14 and protrudes out of the front surface 10 with respect to the lower edge of the front surface 10. When the holding plate 7 is at the fourth position P4, the holding plate 7 is received on the lower edge of the side surface 14 and is aligned with the front surface 10. As above, when the back plate 3 is moved to the first position P1 and provided as the supporting member for the main body 1, the inclined angle of the front surface 10 can be adjusted by adjusting the first angle A1. Moreover, the holding plate 7 at the third position P3 and the front surface 10 are together configured as the supporting structure having the placing space, so that the mobile device can be placed on and abutted on the front surface 10 stably. Hence, the inclined angle of the front surface 10 is adjusted when the user adjusts the viewing angle for the mobile device. Detailed descriptions and advantages about such feature are described as above. In another embodiment, the receiving space 102 is at the intersection between the lower edge of the side surface 14 and the lower edge 100 of the front surface 10, namely, in this embodiment, the receiving space 102 is in communication with the lower edge 100 of the front surface 10 and the lower edge of the side surface 14. For example, as shown in FIG. 7, the receiving space 102 is a groove recessed from the surface of the lower edge of the side surface 14 toward the inner portion of the main body 1, and the depth of the groove and the thickness of the holding plate 7 are substantially the same. When the holding plate 7 is moved to the fourth position P4 and is received in the receiving space 102, the outermost surface of the holding plate 7 and the lower edge of the side surface 14 are aligned with each other and at the same horizontal plane, and the outermost lateral surface of the holding plate 7 is aligned with the front surface 10 and does not protrude from the front surface 10, but embodiments are not limited thereto. In brief, according to one or some embodiments, the holding plate 7 is movable between the third position P3 and the fourth position P4, the holding plate 7 at the third position P3 and the front surface 10 are together configured as the supporting structure having the placing space, and the holding plate 7 at the fourth position P4 is received on the side surface 14. In an exemplary embodiment, the surface of the holding plate 7 further has a non-smooth portion, e.g., a protruding arrow-shaped structure, for indicating the direction for opening the holding plate 7 and for increasing the friction force between the finger and the surface of the holding plate 7. Hence, the user can open the holding plate 7 bare-handedly and conveniently. In one embodiment, the holding plate 7 is slidably connected to the lower edge of the side surface 14.

Please refer to FIGS. 4 and 7. In at least one embodiment, the side surface 14 of the main body 1 has two side covers 144, 146 for respectively covering the first cable 50 and the second cable 52. The positions of the two side covers 144, 146 correspond to the positions of the two side grooves 140, 142. For example, the two side covers 144, 146 are at different sides of the main body 1 and symmetrical to each other, and the two side covers 144, 146 correspond to the two side grooves 140, 142, the first cable 50, and the second cable 52, so that the two cables can be received in the two side grooves 140, 142 and covered by the two side covers 144, 146. Specifically, in this embodiment, the sizes and the outlines of the two side covers 144, 146 correspond to the sizes and the outlines of the two side grooves 140, 142, and the two side covers 144, 146 respectively extend from the lower edge of the side surface 14 toward the side edge and the upper edge of the side surface 14. The first cable 50 and the second cable 52 extend out of the main body 1 from the lower edge of the side surface 14, and the first cable 50 and the second cable 52 are winded so as to be received between the two side grooves 140, 142 and the two side covers 144, 146, respectively. In an exemplary embodiment, the two side covers 144, 146 are detachably disposed on the two side grooves 140, 142 of the side surface 14 and do not protrude out of the side surface 14. Therefore, the two side covers 144, 146 can cover the two side grooves 140, 142 completely. The surfaces of the two side covers 144, 146 are respectively aligned with the side surface 14, thereby providing a neat appearance for the portable power bank. Hence, the first cable 50 and the second cable 52 can be protected and dustproofed.

Based on the above, according to one or some embodiments of the instant disclosure, a portable power bank is provided. The portable power bank can receive the electronic product through the accommodating space 22 of the charging slot 2 properly and charge the electronic product through the output terminal 44 at the surrounding wall 20. Hence, during the charging of the portable power bank to the electronic product, the electronic product can be stably received and held in the charging slot 2, so that a proper connection for charging can be provided. Accordingly, problems of poor charging connection or even charging failures caused by the shaking or the falling off of the portable power bank during the charging can be prevented. Moreover, the difficulties that the electronic products in small volumes cannot be easily charged through cables can be solved. Furthermore, the components of the portable power bank are compactly received in the main body 1. Additionally, when the electronic product is mated with the portable power bank, the electricity can be supplied to the electronic product instantly. Moreover, in some embodiments, the front surface of the portable power bank can be provided for placing a mobile device such as a mobile phone, a tablet computer, a personal digital assistant (PDA), or the like. Moreover, in some embodiments, since the supporting structure can be formed by the holding plate 7 and the front surface 10 of the main body 1, and the first angle A1 between the back plate 3 and the back surface 12 of the main body 1 can be adjusted, the user can adjust the viewing angle for the mobile device to meet the ergonomic requirements. Hence, the portable power bank can provide a body-care function and can relieve fatigue on neck and shoulders. In some embodiments, the portable power bank performs the charging function through the wireless charging coil 6 in the main body 1 and/or the first cable 50 or the second cable 52 at the side surface 14 of the main body 1. Hence, the user can use the portable power bank to perform the charging with various manners.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A portable power bank, comprising:
a main body having a front surface, a back surface opposite to the front surface, and a side surface connected to the front surface and the back surface;
a charging slot capable of receiving an electronic product, wherein the charging slot is at the back surface; the charging slot has a surrounding wall, the surrounding wall is recessed inwardly, and an accommodating space is defined by the surrounding wall;
a back plate pivotally connected to an upper edge of the back surface, wherein the back plate is movable between a first position and a second position; when the back plate is at the first position, a first angle is between the back plate and the back surface of the main body; when the back plate is at the second position, the back plate is received on the back surface; and
a charging module in the main body, wherein the charging module comprises:
a battery;
an input terminal exposed from the main body;
an output terminal at the surrounding wall; and
a conversion circuit electrically connected to the battery, the input terminal, and the output terminal, wherein the conversion circuit is capable of converting received electricity from the input terminal into an output electricity and outputting the output electricity to the battery or to the output terminal, and is further capable of converting stored electricity in the battery into the output electricity and outputting the output electricity to the output terminal.

2. The portable power bank according to claim 1, further comprising a first cable having a first connector and a second cable having a second connector, wherein the first cable and the second cable are electrically connected to the charging module, the side surface has two side grooves for respectively receiving the first cable and the second cable.

3. The portable power bank according to claim 2, wherein the two side grooves are at different sides of the main body, and the two side grooves are symmetrical to each other.

4. The portable power bank according to claim 3, further comprising two side covers for respectively covering the first cable and the second cable, wherein positions of the two side covers correspond to positions of the two side grooves.

5. The portable power bank according to claim 2, wherein the first connector comprises a type-C connector and the second connector comprises a Lightning connector.

6. The portable power bank according to claim 1, wherein the input terminal of the charging module is at the side surface.

7. The portable power bank according to claim 1, wherein the charging module further comprises a wireless charging coil electrically connected to the conversion circuit and corresponding to the front surface, wherein the conversion circuit converts the stored electricity in the battery or the received electricity from the input terminal into the output electricity and outputs the output electricity to the wireless charging coil.

8. The portable power bank according to claim 1, further comprising a holding plate, wherein the holding plate is pivotally connected to a lower edge of the front surface; the holding plate is movable between a third position and a fourth position; when the holding plate is at the third position, a second angle is between the holding plate and the front surface of the main body; when the holding plate is at the fourth position, the holding plate is received on the front surface.

9. The portable power bank according to claim 8, wherein the front surface has a receiving space for receiving the holding plate, the holding plate is received in the receiving space when the holding plate is at the fourth position, and the front surface further has a front finger-shaped recessed portion at an opening portion of the receiving space.

10. The portable power bank according to claim 1, further comprising a holding plate, wherein the holding plate is at a lower edge of the side surface, the holding plate is movable between a third position and a fourth position; when the holding plate is at the third position, the holding plate protrudes from the side surface and the front surface for being configured as a supporting structure having a placing space; when the holding plate is at the fourth position, the holding plate is received on the side surface.

11. The portable power bank according to claim 10, wherein an intersection between the lower edge of the side surface and a lower edge of the front surface has a receiving space for receiving the holding plate, and the holding plate is received in the receiving space when the holding plate is at the fourth position.

12. The portable power bank according to claim 1, wherein the surrounding wall has a back finger-shaped recessed portion at an opening portion of the accommodating space.

13. The portable power bank according to claim 1, wherein the main body further has a separation sheet at a center portion of the accommodating space and connected to the surrounding wall.

14. The portable power bank according to claim 1, wherein an area of the back plate is greater than a cross-sectional area of the accommodating space; when the back plate is at the first position, the back plate is capable of exposing the accommodating space from the back surface of the main body and supporting the main body on a loading surface; when the back plate is at the second position, the back plate is capable of being received in the back surface to cover the accommodating space.
